(19) United States
(12) Patent Application Publication
(10) Pub. No.: US 2023/0048270 A1
(43) Pub. Date: Feb. 16, 2023

(54) SYSTEMS AND METHODS FOR PRODUCT LIFECYCLE AUTOMATION WITH CONSUMER DRIVEN APPLICATIONS

(71) Applicant: AT&T Intellectual Property I, L.P., Atlanta, GA (US)

(72) Inventors: Eric Zavesky, Austin, TX (US); Nigel Bradley, Canton, GA (US); Rashmi Palamadai, Naperville, IL (US)

(73) Assignee: AT&T Intellectual Property I, L.P., Atlanta, GA (US)

(21) Appl. No.: 17/398,630

(22) Filed: Aug. 10, 2021

(51) Int. Cl. G06Q 10/00

(52) U.S. Cl. CPC G06Q 10/30

(57) ABSTRACT

Aspects of the subject disclosure may include, for example, facilitating a first addition to a blockchain of a first transaction, the first addition to the blockchain of the first transaction being based at least in part upon first data that identifies a product; facilitating a second addition to the blockchain of a second transaction, the second addition to the blockchain of the second transaction being based at least in part upon second data that is indicative of a purchase by a consumer of the product; and facilitating a third addition to the blockchain of a third transaction, the third addition to the blockchain of the third transaction being based at least in part upon third data that is indicative of a placement into a recycling stream of the product. Other embodiments are disclosed.

### FIELD OF THE DISCLOSURE

The subject disclosure relates to systems and methods for product lifecycle automation with consumer driven applications.

### BACKGROUND

Recycling is becoming more and more common. Benefits of recycling typically include reduced waste being sent to landfills and conservation of natural resources.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (which can function fully or partially within the communication network of FIG. 1) in accordance with various aspects described herein.

FIG. 2B is a block diagram illustrating an example, non-limiting embodiment of a system (which can function fully or partially within the communication network of FIG. 1) in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for tracking consumer purchasing and recycling of products, and facilitating incentives for such recycling. Other embodiments are described in the subject disclosure.

One or more aspects of the subject disclosure include utilizing one or more blockchains to track consumer (or other entity) purchasing of products.

One or more aspects of the subject disclosure include utilizing one or more blockchains to track consumer (or other entity) recycling of products.

One or more aspects of the subject disclosure include utilizing one or more blockchains to facilitate providing to a consumer (or other entity) one or more incentives (e.g., one or more monetary incentives) for such recycling.

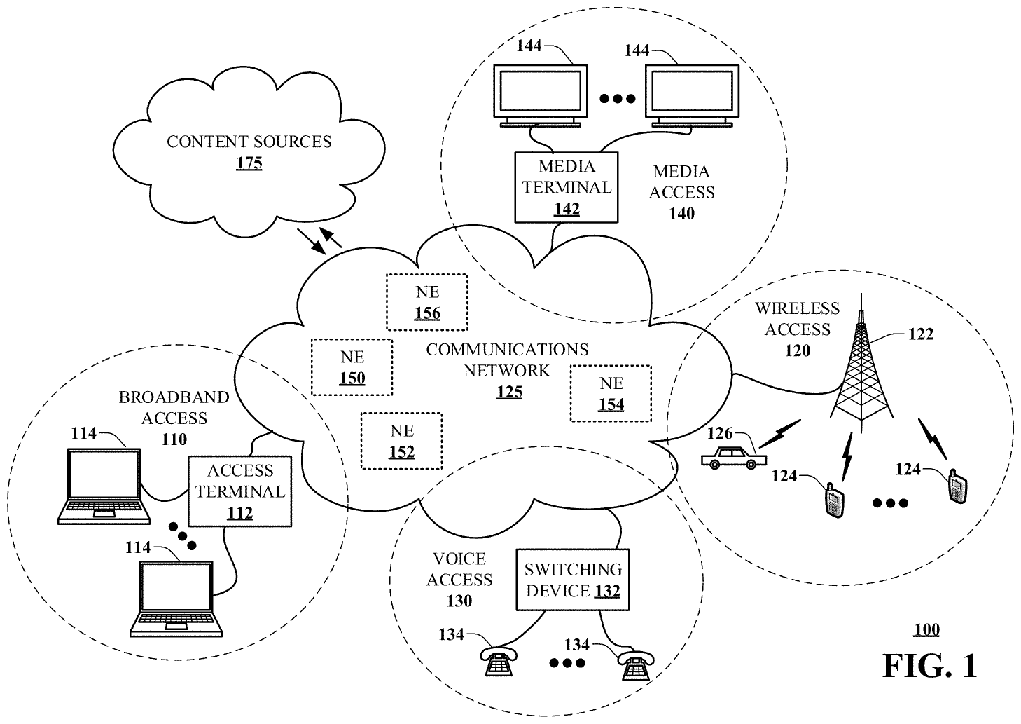

Referring now to FIG. 1, a block diagram is shown illustrating an example, non-limiting embodiment of a system 100 in accordance with various aspects described herein. For example, system 100 can facilitate in whole or in part tracking consumer purchasing and recycling of products, and facilitating incentives for such recycling. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

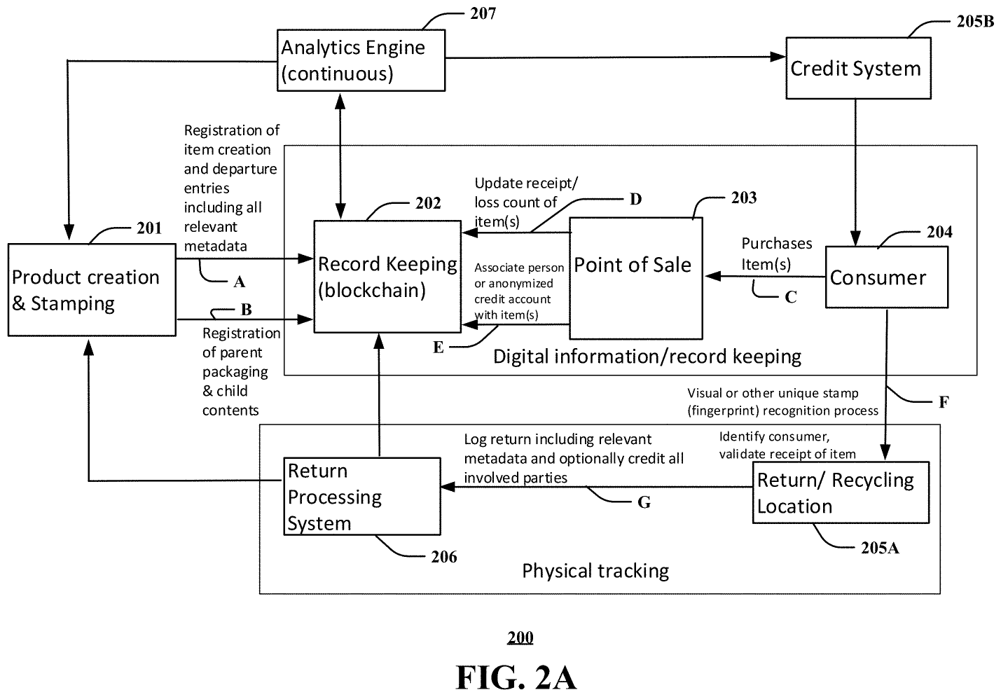

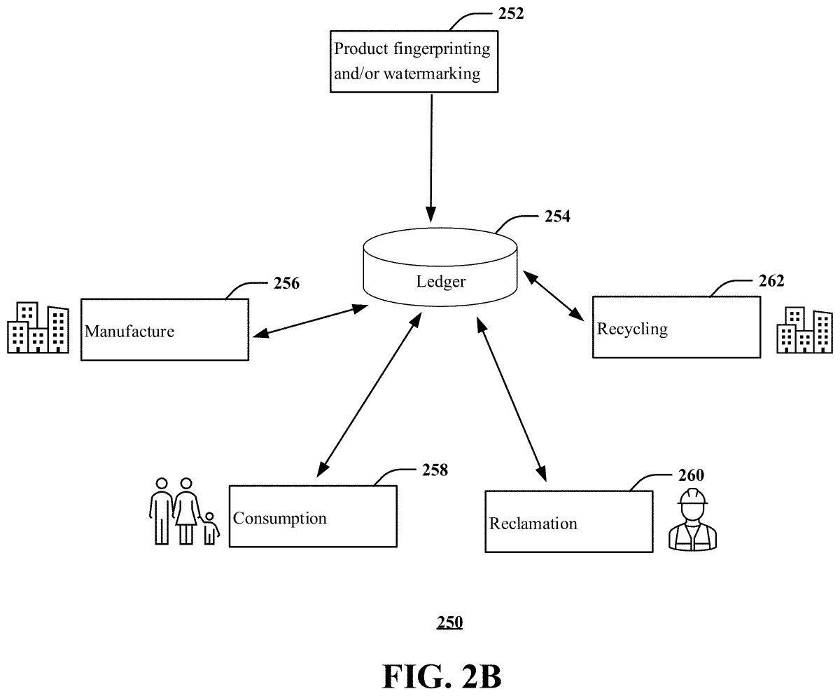

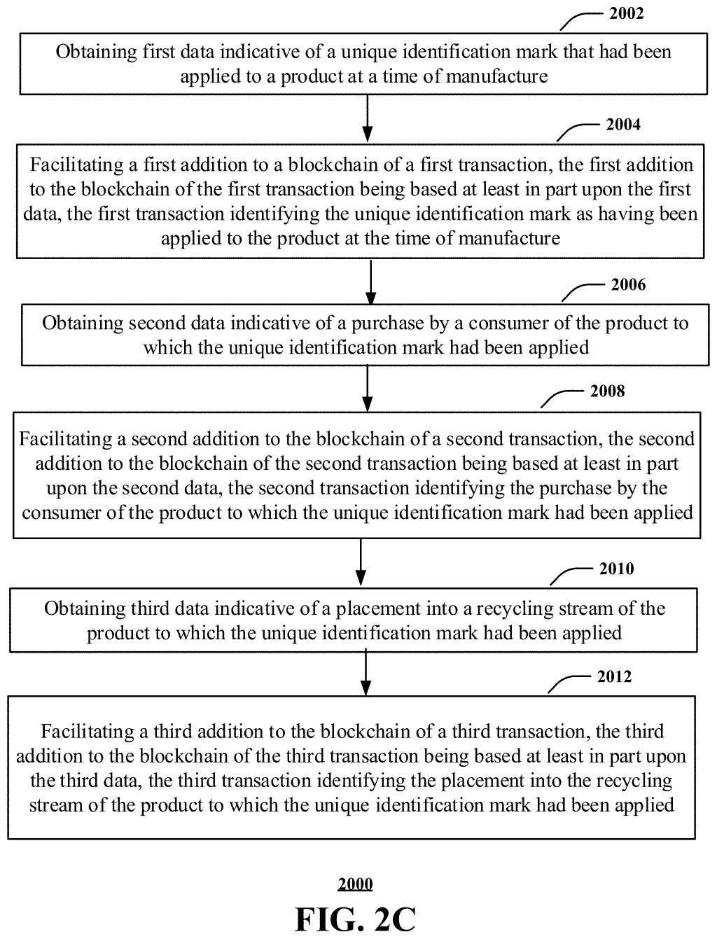

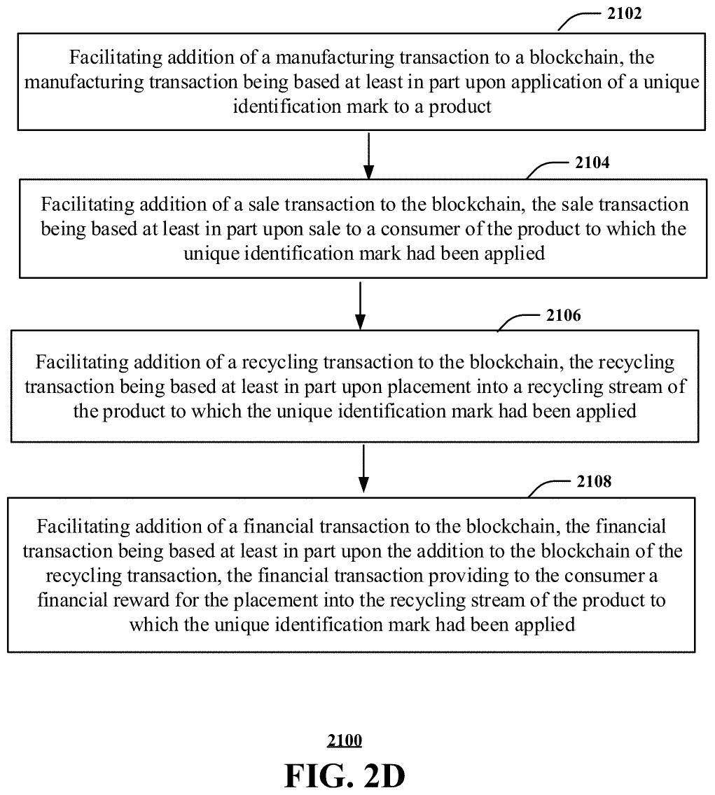

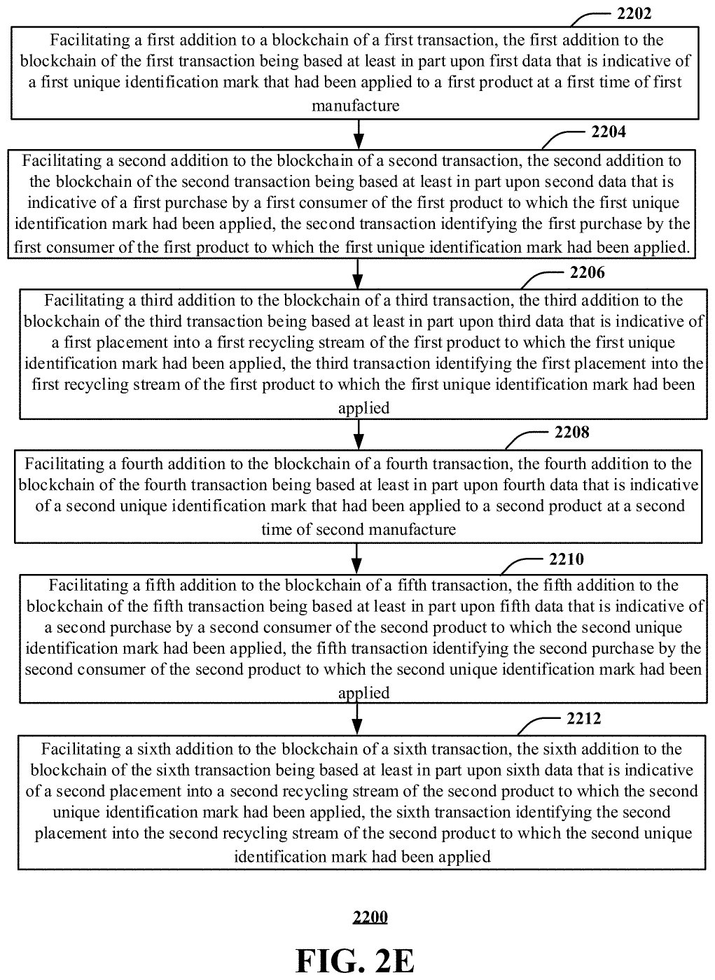

Referring now to FIG. 2A, this is a block diagram illustrating an example, non-limiting embodiment of a system 200 (which can function fully or partially within the communication network of FIG. 1) in accordance with various aspects described herein. As seen in this figure, a mechanism 201 for product creation & stamping provides certain information to mechanism 202 for record keeping (blockchain). More particularly, mechanism 201 provides to mechanism 202 information directed to registration of item creation and departure entries including all relevant metadata (see arrow “A”). In addition, mechanism 201 provides to mechanism 202 information directed to registration of parent packaging & child contents (see arrow “B”). In various examples, the information sent via arrows “A” and/or “B” can be recorded in one or more blockchains.

Still referring to FIG. 2A, it is seen that consumer 204 purchases one or more items (see arrow “C”). In this example, the purchase is made via mechanism 203 at point of sale (e.g., retail point of sale). Further, mechanism 203 provides certain information to mechanism 202. More particularly, mechanism 203 provides to mechanism 202 information directed to updating receipt/loss count of item(s) (see arrow “D”). In addition, mechanism 203 provides to mechanism 202 information directed to associating person or anonymized credit account with item(s) (see arrow “E”). In various examples, the information sent via arrows “C” and/or “D” can be recorded in one or more blockchains.

Still referring to FIG. 2A, it is seen that consumer 204 brings to mechanism 205A, which can comprise a return/recycling location, one or more items for return/recycling (see arrow “F”). In this example, the item(s) can undergo visual or other unique stamp (fingerprint) recognition process. Further, mechanism 205A provides certain information to mechanism 206 for return processing. More particularly, mechanism 205A provides to mechanism 206 information directed to logging of the return, including relevant metadata, and optionally crediting all involved parties (see arrow “G”). Moreover, mechanism 206 provides to mechanism 202 information regarding the returned/recycled item(s). In various examples, the information sent from mechanism 206 to mechanism 202 can recorded in one or more blockchains.

Still referring to FIG. 2A, it is seen that mechanism 202 can be in bi-directional communications with mechanism 207 for performing analytics (e.g., continuously performing analytics). Moreover, mechanism 207 can provide one or more analytic results to mechanism 201, to mechanism 202 and/or to mechanism 205B. In addition, mechanism 205B can function as a credit system to provide credit (e.g., in the form of monetary reward) to consumer 204 (in one example, the monetary reward is based upon the return/recycling actions of the consumer 204).

Still referring to FIG. 2A, it is noted that while one consumer is shown, the system could operate in the context of any desired number of consumers. In addition, it is noted that while one point of sale is shown, the system could operate in the context of any desired number of points of sale. In addition, it is noted that while one return/recycling location is shown, the system could operate in the context of any desired number of return/recycling locations. In addition, it is noted that while one blockchain is shown, the system could operate in the context of any desired number of blockchains.

Reference will now be made to another description of operation according to an embodiment. More particularly, a unique stamp can be embedded in a packaging design (see, e.g., mechanism 201 of FIG. 2A). In various examples, an advanced QR code, barcode, and/or other unique identifier can be used to mark each item. In one specific example, granularity can be by item, not just each item type (e.g., individual soda can, not just object is soda can). In one specific example, the identifiers can be etched, printed, pressed, etc. In another specific example, the visual appearance (e.g., the shape the coloration, the reflectance, and/or the transparency) and/or the material characteristics (e.g., the density, the constructed material, the magnetic inductance, the thermal capacitance, and/or the sound responsiveness to ultra- or infra-sonic frequency emitters, etc.) can be uniquely identified when considered in combination (for example, as a tuple) of one or more properties. In yet another specific example, active sensing can be used and one or more emitters can be attached to the item (for example, if the item had high return value) such that the item signals its location and/or its current state in the recycling lifestyle, and can communicate more directly with the system with regards to its state and travel experience (e.g. shaking, vibrations, etc.). In one specific example, one or more visuals can be sent to an indexing system (e.g., computer vision, thermal, etc.) to generate a unique fingerprint for subsequent analysis. In one specific example, items can each be assigned a score based on some determined returned value (recyclability as one example). In one specific example, each unique ID can be scanned and tied to a new blockchain entry (see, e.g., mechanism 202 of FIG. 2A) which can include location and time of creation, assigned value of object, weight of object empty and full, 3D model of object design, and other metadata. In one specific example, a child node in the block chain can be created upon departure of object including metadata on delivery location. In one specific example, there can be standardization of unique ID placement.

Still referring to this description of operation according to an embodiment reference will now be made to a packaging node in blockchain (see, e.g., mechanism 202 of FIG. 2A). In one specific example, a given packaging node in the blockchain can contain a link to children (e.g., individual items, not just package) identifiers. In one specific example, when a child identifier is scanned the system can log the scan location, source, possible condition, and/or value. In one specific example, the system can put value/item into ‘escrow’ mode that prevents re-scan and usage by others. In another specific example, the system can create representative value tokens that are traded in a market such that physical currency is never realized or exchanged.

Still referring to this description of operation according to an embodiment reference will now be made to item transit and receipt. In one specific example, the system can allow unique product inventory and tracking via blockchain (see, e.g., mechanism 202 of FIG. 2A). In one specific example, in a case that an item is lost during delivery (or stolen), such an individual item can be removed and/or or detected as an anomaly if lost (or stolen) from processing lifecycle. In one specific example, in a case that a consumer receives an item (e.g., during purchase within store or delivery) the item can be associated to the user. In one specific example, a POS (point of sale) ties purchaser to item in blockchain entry (see, e.g., mechanisms 203, 202 of FIG. 2A).

Still referring to this description of operation according to an embodiment reference will now be made to a consumer consuming (using) an item. In one specific example, the system can identify an object via camera and/or computer vision can identify the object by unique identifier. In one specific example, a consumer can schedule item return (e.g., recycling of item). In one specific example, analytics can be aggregated among multiple consumers (see, e.g., mechanism 207 of FIG. 2A).

Still referring to this description of operation according to an embodiment reference will now be made to item transit and schedule. In one specific example, the system can identify return/recycle point (see, e.g., mechanism 205A of FIG. 2A) via location, RFID, computer vision, etc. In one specific example, a return processing system (see, e.g., mechanism 206 of FIG. 2A) can validate object was recycled/returned, log recycle point, return of item, identity of returner. In another specific example, one or more emitters attached to the item can identify themselves and actively signal the system about their location, return needs, and availability for pickup and recycling. In one specific example, the system can notify and log manufacturer return (e.g., responsibility tracing of manufacturer). In one specific example, the system can credit a user for object return (see, e.g., mechanism 205B of FIG. 2A). In one specific example, individuals (e.g., rideshare) or automated entities (e.g., drones, autonomous vehicles, or robots) can be recruited (and/or preemptively compensated) to come to one or more consumers (and/or to a pooled location) and move many recycle objects to other place(s).

Still referring to this description of operation according to an embodiment reference will now be made to return of object to recycle/manufacture facility (see, e.g., mechanism 205A of FIG. 2A). In one example, upon return of the object to the recycle/manufacture facility, the system can determine if some diminished value should be assigned (e.g., making an adjustment to an originally assigned value). In one specific example, the system can a reduce previously assigned credit to a returning user. In one specific example (“Case 1”): the blockchain can be marked as completed lifecycle if broken down to become another object (a blockchain log can be created indicating which items were broken down to create a new item). In one specific example (“Case 2”): an item can be sent for reuse in current state (the blockchain can be updated as +1 for use count, credit user, manufacturer, & other parties for responsible for recycling). In one specific example (“Case 4”): upon receipt of unidentifiable unique ID, scan via RF to sort more easily (beyond unique ID through traditional properties, item can also be routed in recycling facility based on discovered properties such as: discovered by computer vision, thermal characteristics, weight of object, sound/acoustic properties of object, etc.; in addition (or in the alternative) some basic destructive/recycling properties (e.g., tensile, melting, etc.) could be incorporated as method for reuse).

Still referring to this description of operation according to an embodiment reference will now be made to post-mortem for consumer and life-cycle tracking (see, e.g., mechanism 207 of FIG. 2A). In one specific example, the system can track objects point to point throughout their consumption lifecycle (and, when objects don't make it to recycling, analytics can be performed). In one example, the system can determine which parts of the world, state, city, etc. are generating trash/litter which could be recycled. In one specific example, manufacturers can use the return data to optimize return points and/or create local return programs. In one specific example, governmental insight into which companies are not recycling enough can be facilitated.

Referring now to FIG. 2B, this is a block diagram illustrating an example, non-limiting embodiment of a system 250 (which can function fully or partially within the communication network of FIG. 1) in accordance with various aspects described herein. As seen in this figure, mechanism 252 can be used to embed fingerprinting and/or watermarking (e.g., a discrete cosine transform (DCT) watermark) on a product and/or product packaging. Further, data regarding the fingerprinted/watermarked product (and/or packaging) can be supplied to ledger 254. In addition, data regarding manufacture 256, consumption 258, reclamation 260 and/or recycling 262 can be passed back and forth as shown. In one specific example, the ledger itself can incorporate self-triggering mechanisms (e.g., “smart contracts”) such that the completion or satisfaction of one criterion that is updated by the system (e.g., update of a time in the system, update of the location of the item, or the purchase of the item) or environment (e.g., the detection of high temperature in a known storage area for an item) can create or complete subsequent transactions on the ledger itself (e.g., complete or destroy an escrow state, indicate property or ownership transfer, etc.) from which the system can take additional actions as described in FIG. 2A.

As described herein, various embodiments can facilitate incorporation of a unique identifier (see, e.g., mechanism 252 of FIG. 2B) at all points of lifecycle. In one example, a mechanism can be provided for registration of branding images and fingerprints for multiple parts of the product (e.g., image, text, QR, etc.). In one example, a mechanism can facilitate responsibility tracking and analytics—deriving new accountability metrics and identifying weakness in process automatically. In one example, a mechanism can facilitate building a model for standard behavior, and trend analysis can improve structure and performance at each location in the pipeline. In one example, automation can be used for scheduling of pickup and sorting in facilities (e.g., reducing human burden for sorting/analysis). In one example, a blockchain (see, e.g., ledger 254 of FIG. 2B) can be used to implement distributed registration for rewards. In one example, a mechanism can provide for identification/correlation of individuals to specific items in a public setting. In one example, a mechanism can provide for using registrar and escrow properties, and provide for facilitating assignment of value into temporary states. In one example, a mechanism can accommodate damaged items (e.g., decreased reuse capability as auto-detected) and/or lost items in lifecycle (e.g. specifically stolen).

Referring now to FIG. 2C, various steps of a method 2000 according to an embodiment are shown. As seen in this FIG. 2C, step 2002 comprises obtaining first data indicative of a unique identification mark that had been applied to a product at a time of manufacture. Next, step 2004 comprises facilitating a first addition to a blockchain of a first transaction, the first addition to the blockchain of the first transaction being based at least in part upon the first data, the first transaction identifying the unique identification mark as having been applied to the product at the time of manufacture. Next, step 2006 comprises obtaining second data indicative of a purchase by a consumer of the product to which the unique identification mark had been applied. Next, step 2008 comprises facilitating a second addition to the blockchain of a second transaction, the second addition to the blockchain of the second transaction being based at least in part upon the second data, the second transaction identifying the purchase by the consumer of the product to which the unique identification mark had been applied. Next, step 2010 comprises obtaining third data indicative of a placement into a recycling stream of the product to which the unique identification mark had been applied. Next, step 2012 comprises facilitating a third addition to the blockchain of a third transaction, the third addition to the blockchain of the third transaction being based at least in part upon the third data, the third transaction identifying the placement into the recycling stream of the product to which the unique identification mark had been applied.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2D, various steps of a method 2100 according to an embodiment are shown. As seen in this FIG. 2D, step 2102 comprises facilitating addition of a manufacturing transaction to a blockchain, the manufacturing transaction being based at least in part upon application of a unique identification mark to a product. Next, step 2104 comprises facilitating addition of a sale transaction to the blockchain, the sale transaction being based at least in part upon sale to a consumer of the product to which the unique identification mark had been applied. Next, step 2106 comprises facilitating addition of a recycling transaction to the blockchain, the recycling transaction being based at least in part upon placement into a recycling stream of the product to which the unique identification mark had been applied. Next, step 2108 comprises facilitating addition of a financial transaction to the blockchain, the financial transaction being based at least in part upon the addition to the blockchain of the recycling transaction, the financial transaction providing to the consumer a financial reward for the placement into the recycling stream of the product to which the unique identification mark had been applied.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2200 according to an embodiment are shown. As seen in this FIG. 2E, step 2202 comprises facilitating, by a processing system including a processor, a first addition to a blockchain of a first transaction, the first addition to the blockchain of the first transaction being based at least in part upon first data that is indicative of a first unique identification mark that had been applied to a first product at a first time of first manufacture. In one specific example, a blockchain entry can be created and the unique hash (identifier) of that block chain entry can be correlated in the creation of the identification mark itself. In one example, this instantiation can avoid the need for a secondary indexing system that maps block chain entry to a unique identifier. Next, step 2204 comprises facilitating, by the processing system, a second addition to the blockchain of a second transaction, the second addition to the blockchain of the second transaction being based at least in part upon second data that is indicative of a first purchase by a first consumer of the first product to which the first unique identification mark had been applied, the second transaction identifying the first purchase by the first consumer of the first product to which the first unique identification mark had been applied. Next, step 2206 comprises facilitating, by the processing system, a third addition to the blockchain of a third transaction, the third addition to the blockchain of the third transaction being based at least in part upon third data that is indicative of a first placement into a first recycling stream of the first product to which the first unique identification mark had been applied, the third transaction identifying the first placement into the first recycling stream of the first product to which the first unique identification mark had been applied. Next, step 2208 comprises facilitating, by the processing system, a fourth addition to the blockchain of a fourth transaction, the fourth addition to the blockchain of the fourth transaction being based at least in part upon fourth data that is indicative of a second unique identification mark that had been applied to a second product at a second time of second manufacture. Next, step 2210 comprises facilitating, by the processing system, a fifth addition to the blockchain of a fifth transaction, the fifth addition to the blockchain of the fifth transaction being based at least in part upon fifth data that is indicative of a second purchase by a second consumer of the second product to which the second unique identification mark had been applied, the fifth transaction identifying the second purchase by the second consumer of the second product to which the second unique identification mark had been applied. Next, step 2212 comprises facilitating, by the processing system, a sixth addition to the blockchain of a sixth transaction, the sixth addition to the blockchain of the sixth transaction being based at least in part upon sixth data that is indicative of a second placement into a second recycling stream of the second product to which the second unique identification mark had been applied, the sixth transaction identifying the second placement into the second recycling stream of the second product to which the second unique identification mark had been applied.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Additionally, the additions to the blockchain depicted in FIG. 2E may also be accompanied by intermediate steps that are transacted automatically by the blockchain itself (e.g., using “smart contracts” and automatic completion of a payment, location, or transaction by external data) or as intermediaries for a single operation (e.g., repeating step 2212 to indicate that the item has been split among several recycling stream operators or that the item has simply changed hands among several recycling stream operators along its journey to a final operator).

As described herein, various embodiments can provide systems and methods for product lifecycle automation with consumer driven applications.

As described herein, various embodiments can provide: (1) unique item identification; (2) automated trend discovery; and/or (3) stateful ledgers for dissociated rewards.

As described herein, various embodiments can provide a lifecycle management and improvement app (e.g., smartphone app). In one example, there can be unique stamping of objects upon manufacture and upon individual consumption/purchase. In one example, there can be marking for recycle. In one example, unique stamping can utilize fingerprinting registered by the brand and/or object creation at manufacturing plant.

As described herein, various embodiments can provide for tracked objects via use of one or more blockchains.

As described herein, various embodiments can facilitate ride-share/refund-share (e.g., you were going to get 10c for full self-recycle, allow 2c to other person (e.g., ride-share diver) for on-demand pickup).

As described herein, various embodiments can facilitate improvement of sorting line with inclusion of advanced analysis. In one example, such advanced analysis can be used in a case that the unique ID is somehow obfuscated and/or damaged. In one example, such advanced analysis can utilize unique stamping/fingerprinting as described herein. In one specific example, fingerprinting that is registered by the brand and/or object creation at manufacturing plant can be utilized. In one example, advanced CV (computer vision)+EM (electromagnetic) probing+thermal imaging can be used to detect properties of object more quickly (e.g., to sort them to next processing step).

As described herein, various embodiments can facilitate an UBER-like concept where there can be reverse delivery individuals. In one example, mechanisms can facilitate replace/augment areas that don't have true civil recycling centers. In one example, mechanisms can be fitted to smaller areas that don't have recycling centers. In one example, mechanisms can facilitate geofence for pick-up areas that “are” or “are not” well supported by civil capabilities. In one example, mechanisms can be changed by need for seasonal and/or special events. In one example, mechanisms can apply correlations to expiration dates and alerts to throw away item to have better expiration tracking. In one example, mechanisms can facilitate donation/redistribution.

As described herein, various embodiments can provide: (1) For requirement and inclusion of unique item identification; (2) Method for lasting identification of individual property after relinquished to a public setting (e.g. the recycling and reuse pipeline)—for instance, facilitating secure tracking and use of individual items in a dissociated lifecycle (which can be a requirement, for example, for less financially motivated reclamation efforts); (3) Utilization of item lifecycle for smart analytics on trends, needed recycle pickup, improved sorting speed; (4) Analytics at all levels and stages of the process (e.g., from ‘cradle to grave’), promoting accountability and rewards (using, for example, Blockchain as distributed registration for rewards); (5) Incorporation into public records for success metrics and rewards, with options to maintain anonymity; and/or (6) Automation for scheduling of pickup and sorting in facilities (reducing, for example, human burden for sorting/analysis).

As described herein, various embodiments can provide resource planning via blockchain credit analytics.

As described herein, various embodiments can provide for product creation and distribution that are optimized for use in the context of more recycle- and reuse-friendly manufacturing and consumption patterns.

As described herein, various embodiments can provide printing and manufacturing techniques having the ability to uniquely identify and brand a product. For example, instead of creating a brand image that is solely for the purposes of consumer engagement, various embodiments can use computer vision and/or other generation and recognition techniques to facilitate the creation of a brand image that can be uniquely modified to encode specific information (e.g., an item number and/or lot number) without manipulation of the original brand's message.

As described herein, various embodiments can provide a mechanism that encompasses whole-lifecycle tracking of objects, such as to better solve the “cradle to grave” needs of recycling. For example, certain traditional analytics used for anomaly detection in finance and other inventory models can be employed in both a passive (e.g., building models and detecting anomalies or trends) and an active (e.g., sending alerts, calls to action, etc.) tracking and improvement of the recycling lifecycle.

As described herein, various embodiments can provide for the inclusion of public ledgers (e.g., as ordinary blockchain, smart-ledgers and/or split-ledgers) that can enable a rewards and payment system for item(s). In various examples, such rewards and payments systems can be implemented even in a highly volatile process like dissociated (e.g., no one responsible party) collection and processing of recycling items. In various examples, the incorporation of ledger-tracked state changes and concepts like escrow and smart ledgers allows the timely and precise recording and distribution of financial incentives to any actor (e.g., automated, individual, enterprise) involved in the process.

As described herein, various embodiments can provide one or more mechanisms to determine the value and/or use of an object. For instance, beyond unique ID through traditional properties, an item can be routed in a recycling facility based on discovered properties such as can be determined via: computer vision, thermal characteristics, weight of object, sound/acoustic properties of object, or any combination thereof.

As described herein, various embodiments can incorporate one or more IoT (Internet-Of-Things) mechanisms that can auto-scan the consumption of an object as it is placed in recycling cans or upon consumption of the item itself (e.g., a printer cartridge can indicate its rate of use and target recycling facility to the purchaser and/or recycling stream operator).

As described herein, various embodiments can provide on-demand scheduling of ride-share and/or logistics companies to pick up the recycling from individual(s) after one or more thresholds are reached (e.g., after consumer scans with device or based on weight-sensitive recycling can).

As described herein, various embodiments can provide one or more mechanisms via which purchases and/or product lifecycle can be tracked (in one example, there can be an option to maintain anonymity of purchasers/recyclers).

As described herein, various embodiments can provide tracking of one or more objects point-to-point throughout their consumption lifecycle. In one example, when objects don't make it to recycling, analytics can be done to determine which parts of the world are generating trash/litter which could be recycled. In one specific example, such analytics can provide an ability to detect losses in lifecycle (e.g., via process tracking of theft, etc.).

As described herein, various embodiments can provide behavioral insights for both production and consumption in lifecycle for individual objects. In one specific example, such behavioral insights can facilitate an understanding of consumption rate and location. In another specific example, such behavioral insights can facilitate an understanding of the anomalies for recycling and shipping in lifecycle.

As described herein, various embodiments can provide one or more mechanisms to facilitate an increased recycling return rate. In one specific example, certain low return states and/or areas can be identified. In another specific example, one or more programs to increase recycling return rate can be created in certain local areas.

As described herein, various embodiments can provide insight (e.g., governmental insight) into which entities (e.g., which companies) are not recycling enough.

As described herein, various embodiments can provide a rewards mechanism for many participants in the lifecycle (e.g., shipping, point of sales, consumption, and/or return to recycling facilities).

As described herein, various embodiments can provide one or more mechanisms to catalog and enhance the throughput of product tracking and recycling lifecycles.

As described herein, various embodiments can provide for use of blockchain for tracking (e.g., identify consumer, tie piece of plastic container to a purchaser).

As described herein, various embodiments can provide for coverage and targets for certain countries (e.g., US—low vs Germany—high). In one specific example, the coverage and targets can relate to household items and recycling at a given location.

As described herein, various embodiments can provide for a consumer app (e.g., app to track consumer level, how pickup is done, etc.).

As described herein, various embodiments can provide for a drone to crawl (image) a landfill.

As described herein, various embodiments can provide an incentive for picking up plastic from oceans.

As described herein, various embodiments can provide for “reverse” UBER functionality. For instance, allow tagging of plastic piece with disposable and/or reusable tracker that tags a bag to be picked up. In another example, a person can pool/UBER sync to pick up the object as needed.

As described herein, various embodiments can provide for assistive tagging on disposal for easier sorting (which can be coupled, for example, to improvement of sorting line via inclusion of advanced analysis). In one specific example, tagging can be printed/stamped onto an item so that when the item is picked up the sorting process can handle it better. In one specific example, sorting can be validated and processed quickly. In one specific example, sorting can incorporate computer vision in visuals, IR, and/or other mechanism(s) to get to processing (e.g., weight, temp variance, etc.). In one specific example, sorting can comprise temperature testing (e.g., put item in hot room and observe responsiveness to it). In one specific example, sorting can comprise directing EM (electromagnetic radiation) at the item to determine response. In one specific example, sorting can comprise determining violators and/or performing quality analysis (in one specific example, there can be a tie-in between retail and local area analysis for purchases—follow their commitment for recycling).

As described herein, various embodiments can facilitate responsible packaging. For example: additional branding for object(s) to help determine what the object is (e.g., fingerprinting not the logo, model, etc.); register the product visuals for recycling type for recognition on the line; embed shape of object (e.g., bottle)—focus on design of object for category determination and sorting; and/or mandate of shape/materials.

As described herein, various embodiments can provide for tracking of location-based sales of products, such as to ensure that a certain % makes it to recycle. In one specific example, goals can be targeted based on consumption.

As described herein, various embodiments can provide for app tracing/tracking, such as in the context of lifecycle management and improvement app. In one example, points (or other rewards) can be provided for participation. In one example, a financial incentive can be provided for tax and refund in the future. In one example, mechanisms can be provided for unique claiming of an object that has been produced (e.g., from manufacture to consumer) with app that can uniquely ID and tag the item to get recycled. In one example, a timestamp can be provided for location and time (e.g., record on blockchain). In one example, mechanisms can be provided for validating the deposit in an area (e.g., geofence, etc.). In one example, mechanisms can be provided to register garbage by area, etc.

As described herein, various embodiments can provide improvement for unique stamping of objects to recycle for recovery. In one example, mechanisms can be provided for tracking both (stamping and recycling) by consumer (e.g., don't steal my garbage, give me credit at recycling center). In one example, the identifiers can comprise barcode, stamping and/or biodegradable marker. In one example, mechanisms can be provided to register by threshold, such as for preventing recycling “theft”. In one example, certain profiles can have role and/or ability for this (e.g., professional recycler can pick up and dispose).

As described herein, various embodiments can provide for placement of an ID on a high-quality recyclable material.

As described herein, various embodiments can provide a mechanism for a consumer to receive a monetary reward.

As described herein, various embodiments can provide for use of one or more blockchains to initiate and track at various levels (e.g., manufacturer to consumer). In one specific example, tracking can occur and then be updated multiple times.

As described herein, various embodiments can provide for anonymous monetary rewards to customers.

As described herein, various embodiments can provide for identity recovery (e.g., recovery of an item identity) based upon one or more three-dimensional (3D) models (and/or based upon shape, weight and/or reflectivity).

As described herein, various embodiments can provide for an indicator of a point of sale to be bound to an item.

As described herein, various embodiments can provide for scanning of a home garbage can (e.g., via visual, RFID and/or weight measurement mechanisms) in order to identify an item.

As described herein, various embodiments can provide one or more financial incentives for a person (or other entity) to perform recycling.

As described herein, various embodiments can provide for limiting a number of returns from a person (or other entity) who is trying to perform recycling.

As described herein, various embodiments can provide analytics regarding full lifecycle flow (e.g., related to geographic lifecycle). In one example, one or more manufacturers can use results of the analytics to optimize various processes (e.g., manufacturing processes).

As described herein, various embodiments can provide a centralized system that “fingerprints” each item.

As described herein, various embodiments can provide, such as at a manufacturing stage, each item (e.g., each bottle) with a unique shape (e.g., uniquely shaped divot, uniquely located divot, uniquely shaped texture and/or uniquely located texture).

As described herein, various embodiments can test, such as at a checkpoint stage, each item (e.g., each bottle) to determine the item's unique shape (e.g., uniquely shaped divot, uniquely located divot, uniquely shaped texture and/or uniquely located texture).

As described herein, various embodiments can alter, such as at a checkpoint stage, each item (e.g., each bottle) to alter the item's unique shape (e.g., uniquely shaped divot, uniquely located divot, uniquely shaped texture and/or uniquely located texture).

As described herein, various embodiments can utilize globally unique identifiers.

As described herein, various embodiments can utilize locally unique identifiers (e.g., unique at a country level, unique at a state level, unique at a city level).

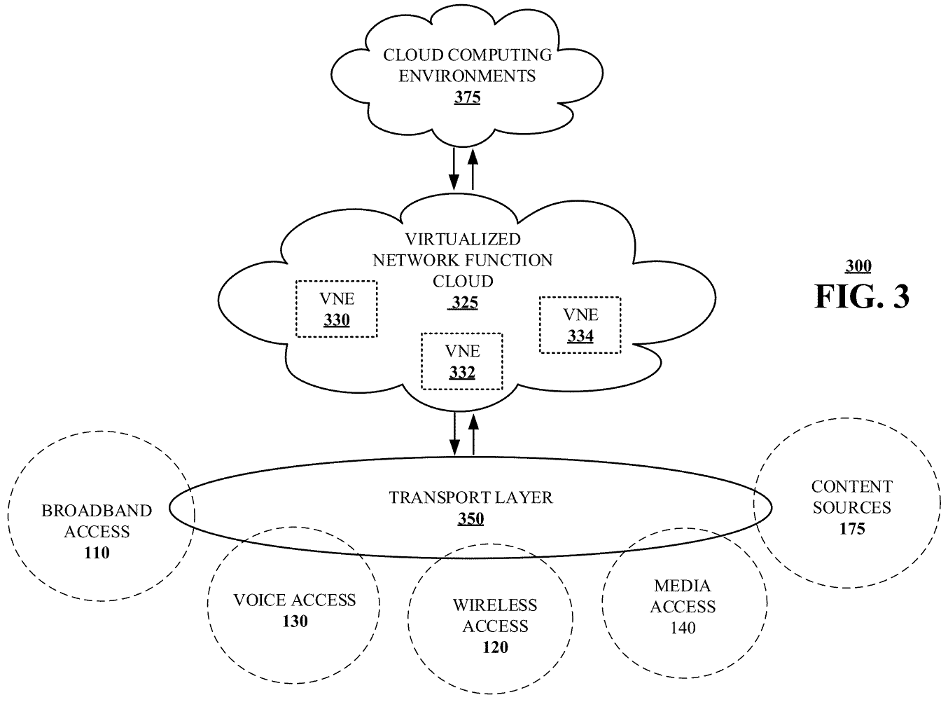

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100 of FIG. 1, some or all of the subsystems and functions of system 200 of FIG. 2A, some or all of the subsystems and functions of system 250 of FIG. 2B and/or some or all of methods 2000, 2100 and/or 2200 of FIGS. 2C, 2D, 2E. For example, virtualized communication network 300 can facilitate in whole or in part tracking consumer purchasing and recycling of products, and facilitating incentives for such recycling.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

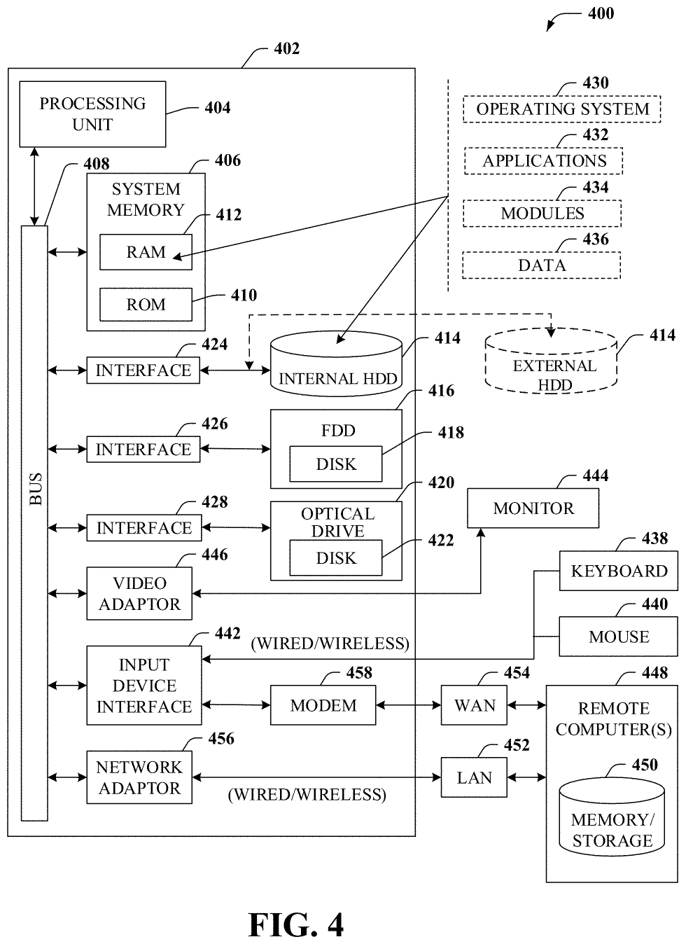

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part tracking consumer purchasing and recycling of products, and facilitating incentives for such recycling.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

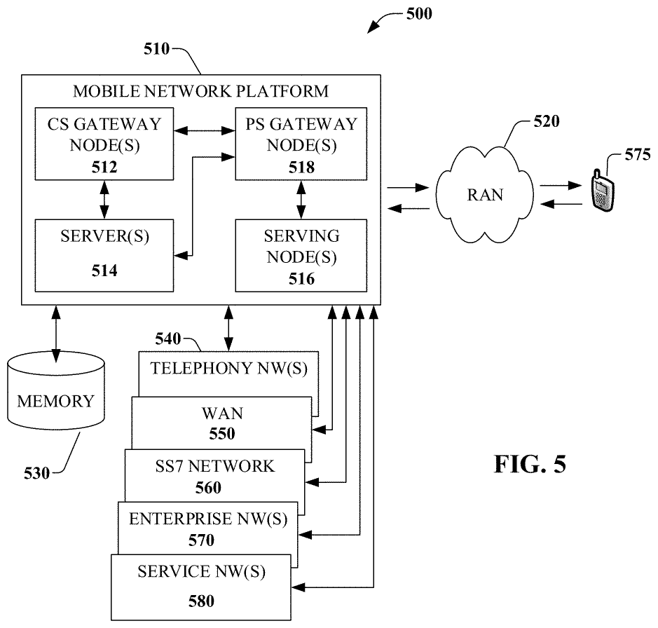

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part tracking consumer purchasing and recycling of products, and facilitating incentives for such recycling. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

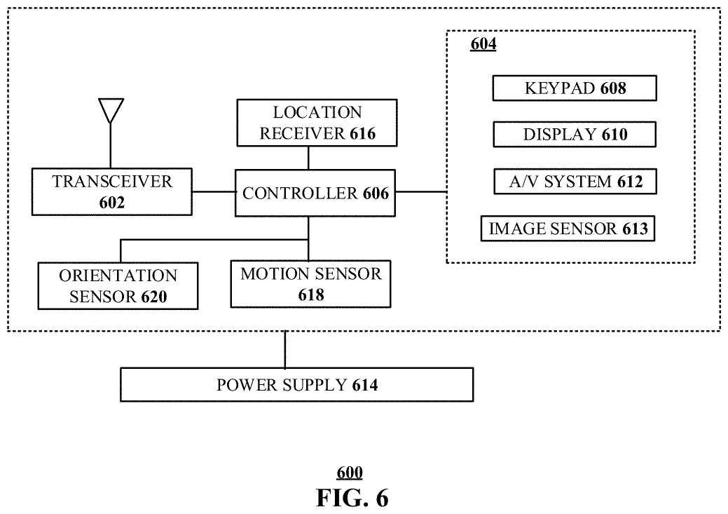

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part tracking consumer purchasing and recycling of products, and facilitating incentives for such recycling.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically tracking consumer purchasing and recycling of products, and facilitating incentives for such recycling) can employ various AI-based schemes for carrying out various embodiments thereof. Moreover, the classifier can be employed to determine a ranking or priority of each purchase action and/or of each recycling action. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria a value of each purchase action and/or of each recycling action, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
facilitating a first addition to a blockchain of a first transaction, the first addition to the blockchain of the first transaction being based at least in part upon first data that identifies a product;
facilitating a second addition to the blockchain of a second transaction, the second addition to the blockchain of the second transaction being based at least in part upon second data that is indicative of a purchase by a consumer of the product; and
facilitating a third addition to the blockchain of a third transaction, the third addition to the blockchain of the third transaction being based at least in part upon third data that is indicative of a placement into a recycling stream of the product.

2. The device of claim 1, wherein:
the first data is indicative of a unique identification mark that had been applied to the product at a time of manufacture;
the operations further comprise obtaining the first data the second data is indicative of the purchase by the consumer of the product to which the unique identification mark had been applied;
the operations further comprise obtaining the second data;
the third data is indicative of the placement into the recycling stream of the product to which the unique identification mark had been applied; and
the operations further comprise obtaining the third data.

3. The device of claim 1, wherein:
the first data is indicative of a unique identification mark that had been applied to the product at a time of manufacture; and
the unique identification mark is globally unique.

4. The device of claim 1, wherein:
the first data is indicative of a unique identification mark that had been applied to the product at a time of manufacture; and
the unique identification mark is unique within a region.

5. The device of claim 4, wherein the region comprises: a geographic subdivision; a political subdivision; or any combination thereof.

6. The device of claim 5, wherein the geographic subdivision comprises a continent.

7. The device of claim 5, wherein the political subdivision comprises: a country; a state; a county; a city; a province; or any combination thereof.

8. The device of claim 1, wherein:
the first data is indicative of a unique identification mark that had been applied to the product at a time of manufacture; and
the unique identification mark comprises: printing that is applied to the product; printing that is applied to packaging of the product; a label that is applied to the product; a label that is applied to packaging of the product; a texture that is applied to the product; a texture that is applied to packaging of the product; one or more physical features that are applied to the product; one or more physical features that are applied to packaging of the product; or any combination thereof.

9. The device of claim 1, wherein:
the first data is obtained from a manufacturer of the product; and
the second data is obtained from a retail seller of the product to the consumer, the second data is obtained at a point of sale of the product to the consumer, or any combination thereof.

10. The device of claim 1, wherein the third data is obtained after placement of the product by the consumer into the recycling stream.

11. The device of claim 10, wherein the third data is obtained after placement of the product by the consumer for curbside recycling pickup.

12. The device of claim 10, wherein the third data is obtained after placement of the product by the consumer into a recycling collection machine at a store.

13. The device of claim 1, wherein:
the first data is indicative of a unique identification mark that had been applied to the product at a time of manufacture;
the second data is indicative of the purchase by the consumer of the product to which the unique identification mark had been applied;
the third data is indicative of the placement into the recycling stream of the product to which the unique identification mark had been applied; and
the operations further comprise:
obtaining the first data;
obtaining the second data;
obtaining the third data;
responsive to the obtaining the third data indicative of the placement into the recycling stream of the product to which the unique identification mark had been applied, facilitating provision of a monetary credit to the consumer; and
facilitating a fourth addition to the blockchain of a fourth transaction, the fourth addition to the blockchain of the fourth transaction being based at least in part upon the facilitating the provision of the monetary credit to the consumer, the fourth transaction identifying the provision of the monetary credit to the consumer.

14. The device of claim 1, wherein:
the first data is indicative of a unique identification mark that had been applied to the product at a time of manufacture; and
the operations further comprise:
obtaining the first data;
obtaining the second data;
obtaining the third data;
obtaining fourth data indicative of another unique identification mark that had been applied to another product at another time of manufacture;
facilitating a fourth addition to the blockchain of a fourth transaction, the fourth addition to the blockchain of the fourth transaction being based at least in part upon the fourth data, the fourth transaction identifying the another unique identification mark as having been applied to the another product at the another time of manufacture;
obtaining fifth data indicative of another purchase by another consumer of the another product to which the another unique identification mark had been applied;
facilitating a fifth addition to the blockchain of a fifth transaction, the fifth addition to the blockchain of the fifth transaction being based at least in part upon the fifth data, the fifth transaction identifying the another purchase by the another consumer of the another product to which the another unique identification mark had been applied;
obtaining sixth data indicative of another placement into the recycling stream of the another product to which the another unique identification mark had been applied; and
facilitating a sixth addition to the blockchain of a sixth transaction, the sixth addition to the blockchain of the sixth transaction being based at least in part upon the sixth data, the sixth transaction identifying the another placement into the recycling stream of the another product to which the another unique identification mark had been applied.

15. A non-transitory machine-readable medium comprising executable instructions that, when executed by a processing system including a processor, perform operations, the operations comprising:
facilitating addition of a manufacturing transaction to a blockchain, the manufacturing transaction being based at least in part upon application of a unique identification mark to a product;
facilitating addition of a sale transaction to the blockchain, the sale transaction being based at least in part upon sale to a consumer of the product to which the unique identification mark had been applied;
facilitating addition of a recycling transaction to the blockchain, the recycling transaction being based at least in part upon placement into a recycling stream of the product to which the unique identification mark had been applied; and
facilitating addition of a financial transaction to the blockchain, the financial transaction being based at least in part upon the addition to the blockchain of the recycling transaction, the financial transaction providing to the consumer a financial reward for the placement into the recycling stream of the product to which the unique identification mark had been applied.

16. The non-transitory machine-readable medium of claim 15, wherein the operations further comprise facilitating payment to the consumer of the financial reward.

17. The non-transitory machine-readable medium of claim 15, wherein the operations further comprise:
facilitating addition of another manufacturing transaction to the blockchain, the another manufacturing transaction being based at least in part upon application of another unique identification mark to another product;
facilitating addition of another sale transaction to the blockchain, the another sale transaction being based at least in part upon another sale to another consumer of the another product to which the another unique identification mark had been applied;
facilitating addition of another recycling transaction to the blockchain, the another recycling transaction being based at least in part upon another placement into the recycling stream of the another product to which the another unique identification mark had been applied; and
facilitating addition of another financial transaction to the blockchain, the another financial transaction being based at least in part upon the addition to the blockchain of the another recycling transaction, the another financial transaction providing to the another consumer another financial reward for the placement into the recycling stream of the another product to which the another unique identification mark had been applied.

18. A method comprising:
facilitating, by a processing system including a processor, a first addition to a blockchain of a first transaction, the first addition to the blockchain of the first transaction being based at least in part upon first data that is indicative of a first unique identification mark that had been applied to a first product at a first time of first manufacture;
facilitating, by the processing system, a second addition to the blockchain of a second transaction, the second addition to the blockchain of the second transaction being based at least in part upon second data that is indicative of a first purchase by a first consumer of the first product to which the first unique identification mark had been applied, the second transaction identifying the first purchase by the first consumer of the first product to which the first unique identification mark had been applied;
facilitating, by the processing system, a third addition to the blockchain of a third transaction, the third addition to the blockchain of the third transaction being based at least in part upon third data that is indicative of a first placement into a first recycling stream of the first product to which the first unique identification mark had been applied, the third transaction identifying the first placement into the first recycling stream of the first product to which the first unique identification mark had been applied;
facilitating, by the processing system, a fourth addition to the blockchain of a fourth transaction, the fourth addition to the blockchain of the fourth transaction being based at least in part upon fourth data that is indicative of a second unique identification mark that had been applied to a second product at a second time of second manufacture;
facilitating, by the processing system, a fifth addition to the blockchain of a fifth transaction, the fifth addition to the blockchain of the fifth transaction being based at least in part upon fifth data that is indicative of a second purchase by a second consumer of the second product to which the second unique identification mark had been applied, the fifth transaction identifying the second purchase by the second consumer of the second product to which the second unique identification mark had been applied; and
facilitating, by the processing system, a sixth addition to the blockchain of a sixth transaction, the sixth addition to the blockchain of the sixth transaction being based at least in part upon sixth data that is indicative of a second placement into a second recycling stream of the second product to which the second unique identification mark had been applied, the sixth transaction identifying the second placement into the second recycling stream of the second product to which the second unique identification mark had been applied.

19. The method of claim 18, wherein the first recycling stream and the second recycling stream are a same recycling stream.

20. The method of claim 18, further comprising:
facilitating, by the processing system, a seventh addition to the blockchain of a seventh transaction, the seventh addition to the blockchain of the seventh transaction being based at least in part upon seventh data that is indicative of a third unique identification mark that had been applied to a third product at a third time of third manufacture;
facilitating, by the processing system, an eighth addition to the blockchain of an eighth transaction, the eighth addition to the blockchain of the eighth transaction being based at least in part upon eighth data that is indicative of a third purchase by the first consumer of the third product to which the third unique identification mark had been applied, the eighth transaction identifying the third purchase by the first consumer of the third product to which the third unique identification mark had been applied;
facilitating, by the processing system, a ninth addition to the blockchain of a ninth transaction, the ninth addition to the blockchain of the ninth transaction being based at least in part upon ninth data that is indicative of a third placement into the first recycling stream of the third product to which the third unique identification mark had been applied, the ninth transaction identifying the third placement into the first recycling stream of the third product to which the third unique identification mark had been applied;
facilitating, by the processing system, a tenth addition to the blockchain of a first financial transaction, the first financial transaction being based at least in part upon the third addition to the blockchain of the third transaction, the first financial transaction providing to the first consumer a first financial reward for the first placement into the first recycling stream of the first product to which the first unique identification mark had been applied;
facilitating, by the processing system, an eleventh addition to the blockchain of a second financial transaction, the second financial transaction being based at least in part upon the sixth addition to the blockchain of the sixth transaction, the second financial transaction providing to the second consumer a second financial reward for the second placement into the second recycling stream of the second product to which the second unique identification mark had been applied; and
facilitating, by the processing system, a twelfth addition to the blockchain of a third financial transaction, the third financial transaction being based at least in part upon the ninth addition to the blockchain of the ninth transaction, the third financial transaction providing to the first consumer a third financial reward for the third placement into the first recycling stream of the third product to which the third unique identification mark had been applied.
